(19) United States
(12) Patent Application Publication
(10) Pub. No.: US 2004/0044512 A1
(43) Pub. Date: Mar. 4, 2004

(54) Method and apparatus for increasing a number of operating states of a circuit device

(75) Inventor: Daniel Cross, Boca Raton, FL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/230,717

(22) Filed: Aug. 29, 2002

(51) Int. Cl. G06F 17/50; G06F 1/00

(52) U.S. Cl. 703/16; 327/334

(57) ABSTRACT

An input control signal within a range corresponding to static operating states of a circuit device (18) is applied to an input terminal (12). A sigma delta modulator (14) quantizes the input control signal. An output terminal (16) subsequently applies the quantized signal to the circuit device (18) for selecting a new operating state different than the static operating states by rapidly switching between operating states of the circuit device to generate a time averaged response of the circuit device that is within the range corresponding to the static operating states of the circuit device and consistent with the input control signal.

### FIELD OF THE INVENTION

The present invention relates generally to circuit devices with static operating states, and, more particularly, to a method and apparatus for increasing the number of effective operating states of such circuit devices.

### BACKGROUND OF THE INVENTION

Applications of an electrical circuit often require that the response or operating parameters of the electrical circuit be changed electronically during operation. Generally, the electrical circuit must be designed with a number of static operational states that correspond to the accuracy or resolution of the required changes.

For example, a filtering circuit might be implemented with a number of similar static elements, such as capacitors, which are connected to the circuit via switches. Electronically opening or closing selected switches can select a desired filter operational response. However, a separate switch and capacitor branch is required for each desired filter response. Increasing the number of filter responses requires adding a corresponding number of switches and branches. Such a design would be very difficult and costly. However, a high number of filter responses are necessary in order to tune a circuit with a high degree of accuracy or resolution.

Therefore, what is needed is a device that can increase the number of operating states of an electrical circuit with limited, if any, modifications to the electrical circuit.

### BRIEF DESCRIPTION OF THE DRAWINGS

Objects and advantages of the present invention will be more readily apparent from the following detailed description of the preferred embodiments thereof when taken together with the accompanying drawings in which:

FIG. 1 is a block diagram of a device according to the present invention;

FIG. 2 is a block diagram of a preferred embodiment of a filter circuit according to the present invention;

FIG. 3 is a graph illustrating different levels of an input signal applied to a modulator of the device of FIG. 1;

FIG. 4 is a graph illustrating an output signal of the modulator for the different levels of the input signal;

FIG. 5 is a graph illustrating the performance of a filter device for the different levels of the input signals; and

FIG. 6 is a block diagram of a preferred embodiment of a modulator of the device according to the present invention.

### DETAILED DESCRIPTION OF THE PREFERRED EMBODIMENTS

The instant disclosure is provided to further explain in an enabling fashion the best modes of performing the embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions and integrated circuits (ICs) such as application specific or custom ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

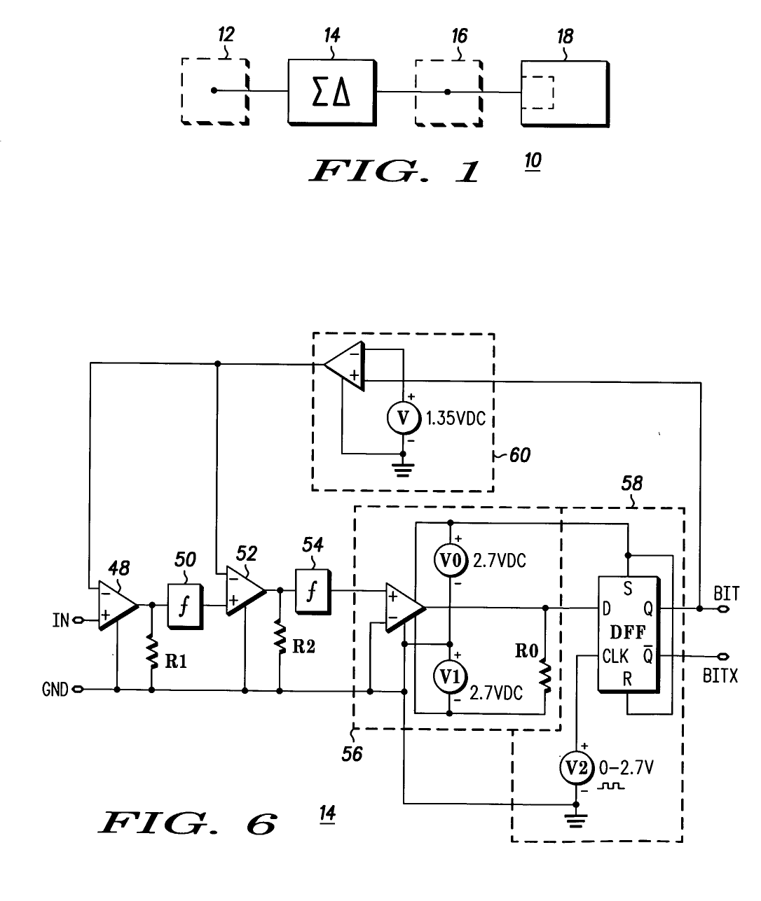

Referring now to the drawings in which like numerals reference like parts, FIG. 1 shows a block diagram of the device (device) 10 according to a generic implementation of the present invention. As will be more fully discussed below, the device 10 is for increasing a number of effective operating states of a circuit device 18. The device 10 includes an input device 12, a modulator 14, an output device 16, and the circuit device 18. Each of these will be discussed in detail below.

The input device 12 is for receiving an input control signal and may be, for example, one or more input terminals. As will be more fully discussed below, the input control signal applied to the input device 12 should be within a range corresponding to and preferably between control signals for or that set the static operating states of the circuit device 18.

The modulator 14 is for quantizing the input control signal for matching the input control signal to one or more static operating states of the circuit device. In the preferred form the modulator will switch or toggle between two states corresponding to two states of the circuit device in such a manner as to spend on a percentage basis a proportion of time that corresponds to the input control signal at one of the states and thus the other state as well. An exemplary modulator is shown in FIG. 6 in which the modulator 14 is a second order sigma delta modulator. However, the modulator 14 of the present invention is not limited to second order sigma delta modulators. Other modulators of different order may also be used.

The exemplary modulator 14 includes a first amplifier 48 for amplifying the input control signal with a buffered feedback for generating a first amplified output, a first integrator 50 for integrating the first amplified output to generate a first integrated output, a second amplifier 52 for amplifying the first integrated output with the buffered feedback and generating a second amplified output, a second integrator 54 for integrating the second amplified output and generating a second integrated output, a quantizer circuit 56 for generating a quantized signal based upon the second integrated output, a latch circuit 58 for providing clock control to switch the quantized signal to an output “BIT” and “BITX” and a buffer 60 for comparing the output BIT to a reference level (1.35 V in the preferred form) to provide the buffered feedback or feedback signal.

The amplifiers 48, 52 above are functionally adders or unity gain amplifiers whose outputs are equal to the difference between the signals at their respective inputs, e.g. (IN—buffered feedback) for amplifier 48. The quantizer circuit includes a comparator that compares the second integrator output to a ground potential and provide a maximum positive output if the integrator output is greater than ground and a maximum negative output if the integrator output is less than ground. The latch circuit operates as a D flip flop that is clocked by a clock V2 that in a preferred form is a 4 MHz square wave. The latch circuit controls the maximum frequency that the output BIT can change. Note the output will not necessarily change at this frequency but cannot switch at any greater frequency. Usually this clock frequency is set at approximately 10 times the largest frequency of interest. The buffer 60 is a comparator that provides a maximum output of 2.7V if the BIT is positive (2.7V) exceeding the 1.35V reference and a minimum or zero output if the BIT is zero.

During operation of the modulator 14, an input control signal, such as an analog signal of 1.35 V is received via the input terminal 12. This input control signal is added to the buffered feedback or the buffered feedback is subtracted from the input signal and amplified with gain one by the first amplifier 48 to provide or generate the first amplified output. The buffered feedback is either 0 or 2.7 V (logic level 0 or 1) for this particular embodiment of modulator 14. The first integrator 50 either adds or subtracts the first amplified output to a sum that is stored therein depending on whether the first amplified output is positive or negative, respectively. This sum (first integrated output) is coupled to the second amplifier 52, which subsequently adds (or subtracts given the input polarities) the first integrated output to the buffered feedback and amplifies with gain one the result in a manner similar to the first amplifier 48 to provide or for generating a second amplified output. The second integrator 54 in a manner similar to the first integrator 50 integrates this second amplified output. The second integrated output is coupled to the quantizer circuit 56. In this particular modulator 14, the quantizer circuit 56 is a one-bit quantizer for a two state circuit device. Therefore, if the second integrated output is greater than zero or ground, the quantizer circuit 56 generates a high output signal, such as 2.7 V. The quantizer circuit 56 generates a low signal, such as −2.7 V if the second integrated output is less than zero or ground. This signal is fed to the latch circuit 58, which subsequently generates the output signal at, preferably a 4 MBit rate, as a digital 1 or 0 corresponding to 2.7V or 0V, respectively. The maximum frequency of the switching is determined by the clock signal, which is selected in accordance with the frequency range of signals to be processed by the circuit device 18 (here 4 MHz is used as the upper frequency of signals to be processed by the circuit device is less than 400 KHz. The output signal is returned to a buffer 60 for amplifying the output signal and coupling it back to the amplifiers 48, 52 as either 2.7 V or 0 V. Note that the modulator includes an output BIT and an inverted output BITX that is a logically inverted version of BIT.

Referring back to FIG. 1, the device 10 also includes an output device 16, such as one or more terminals for applying the quantized signal to the circuit device 18 and activating, one at a time, the static operating states of the circuit device 18. The circuit device 18, via the quantizer circuit 56 as limited by the latch circuit 58, switches between static operating states in a specific pattern based on the output signals provided by the latch circuit 58. The specific pattern of the output of the latch circuit 58 is a psuedo random pattern that over the long term repeats but over any short-term period resembles a random signal. The pattern has known and time invariant statistical properties such as a mean that will correspond to the input control signal. Another way of viewing this is that the output signal at the latch circuit will spend a given proportion of time at one of the two static operating state levels that directly corresponds or correlates to the input control signal and conversely at the other static operating state a proportion of time that inversely corresponds to the input control signal. The input device 12 and the output device 16 are essentially inputs and outputs of the modulator 14. The modulator 14 and circuit device 18 can be fabricated as a single integrated circuit using generally known and available semiconductor fabrication processes.

The circuit device 18 may be, for example, an amplifier, oscillator, filter or any frequency generating device with a number of static operating states. The term ‘static operating states’ refers to the number of preset or predetermined or predefined operating states for the circuit device 18. For example, a filter may have two static filtering levels or frequency responses or an amplifier may have two static gain levels. As will be discussed below, the modulator 14 can dynamically and advantageously add new effective operating states to the circuit device 18.

During operation of the device 10, an input control signal is chosen that corresponds to an input control signal for activating a new operating state that is within a range of the static operating states of the circuit device 18. For example, if a filter has two operating states, such as two corner frequencies or two frequency responses with one response activated with a 0 V input and another with a 2.7 V input a control signal within the range of 0 V to 2.7 V will result in a new operating state or effective operating state with a corner frequency somewhere between the static corner frequencies. This input control signal is applied to the modulator 14 via the input device 12. The modulator 14 generates a signal or quantized signal that matches or corresponds to the input control signal and that has states that are equivalent to the control signal required to activate the static operating states of the circuit device 18. More specifically, the quantizer circuit 56 generates output signals corresponding to the static operating states of the circuit device 18, however the proportion of time spent at each operating state will vary with the input control signal. This may be thought of as the modulator 14 providing output signals in accordance with a specific pattern where the specific pattern is determined by the internal modulator feedback (via the buffer 60) and the specifics of the input control signal. In accordance of this specific pattern provided at the modulator 14 output, the circuit device 18 is commanded or driven, via the output terminal 16, to rapidly and correspondingly switch between its static operating states. The rate of this switching is also in accordance with the specific pattern. A time averaged response of the circuit device 18 shows that it is operating at the new operating state consistent with the input control signal.

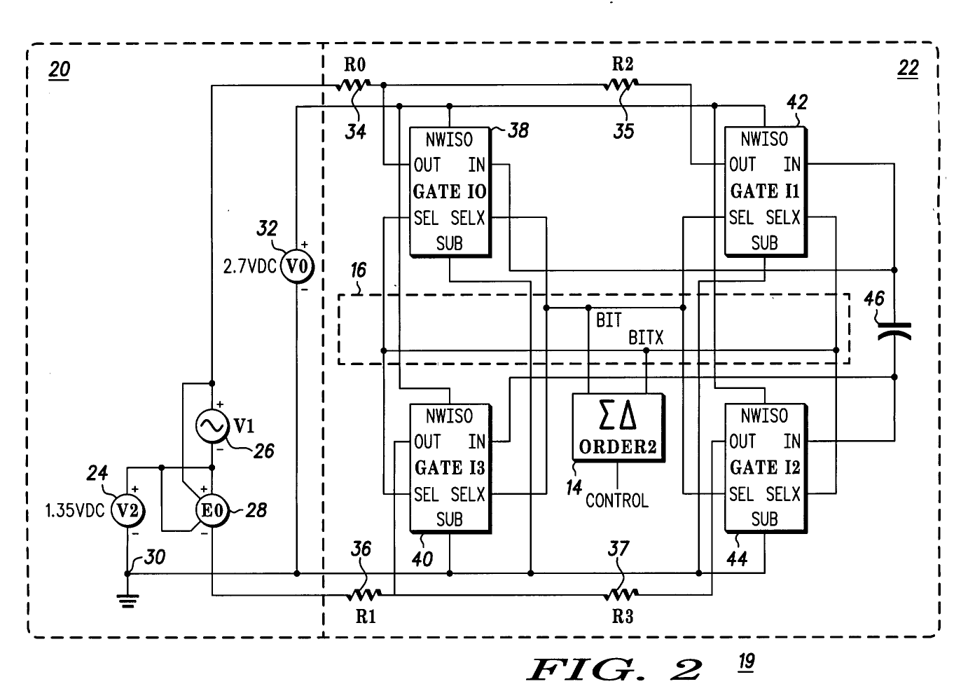

Referring to FIG. 2, an embodiment of the present invention will be discussed in which the present invention is implemented in a filter device 19. The filter device 19 is a specific embodiment of the circuit device 18 together with the just discussed modulator 14 of FIG. 6. The filter device 19 includes a filter input circuit 20 and a filtering operation circuit 22. The filter input circuit 20 includes a voltage source V2 24 for setting a common mode bias voltage, input voltage source V1 26 and a unity gain voltage controlled voltage source E0 28 (tracks V1 and generates a differential input signal) for generating the input signal that will be filtered, a ground connection 30 for providing a substrate connection to ground and voltage source V0 32, here 2.7 VDC, for providing a power supply bias for transmission gates in the filtering circuit 22.

The filtering circuit 22 includes a first high resistor R0 34 and a second high resistor R1 36 for generating a high frequency filtering or high corner frequency or high frequency response, and a first low resistor R2 35 and a second low resistor R3 37 for generating a low frequency filtering or low corner frequency or low frequency response when series coupled with R0 and R1, respectively. The filtering circuit 22 also includes a first high transmission gate 38 and a second high transmission gate 40 in electronic communication with the first and second high resistors 34, 36, a first low transmission gate 42 and a second low transmission gate 44 in electronic communication with the first and second low resistors 35, 37, and a filter capacitor 46 in electronic communication with and series coupled between the high and low transmission gates 38, 40 and 42, 44, respectively. The output signal from the filter is a differential signal that appears across capacitor 46.

The modulator 14 is in electronic communication with or coupled to the transmission gates 38, 40, and 42, 44 via the output device 16 or more specifically the BIT and BITX outputs from the modulator 14. The filter device 19 has two static filtering levels that correspond to the high resistors 34, 36 and the low resistors 35, 37, respectively, as noted above. The high filtering level or high frequency response is activated by enabling high transmission gates 38 and 40 while disabling low transmission gates 42, 44 thereby creating an RC filter including a series connection of R0, capacitor 46, and R1. More specifically the high filtering level or high frequency response is activated by applying a voltage of 2.7 V via the BITX output to the SEL inputs of high transmission gates 38, 40 and to the SELX input of low transmission gates 42, 44 and applying a voltage of 0 V via the BIT output to the SELX inputs of high transmission gates 38, 40 and the SEL inputs of low transmission gates 42, 44. Conversely the low filtering level or low frequency response with low frequency corner is activated by enabling low transmission gates 42, 44 by applying 2.7 V to their SEL inputs and disabling high transmission gates 38. 40 by applying a voltage of 0 V to their SEL inputs, with the details left to the reader given the above discussion. This results in forming a second RC filter including a series connection of R0 plus R2, capacitor 46, and R3 plus R1, which will have a lower corner frequency than the above discussed RC filter.

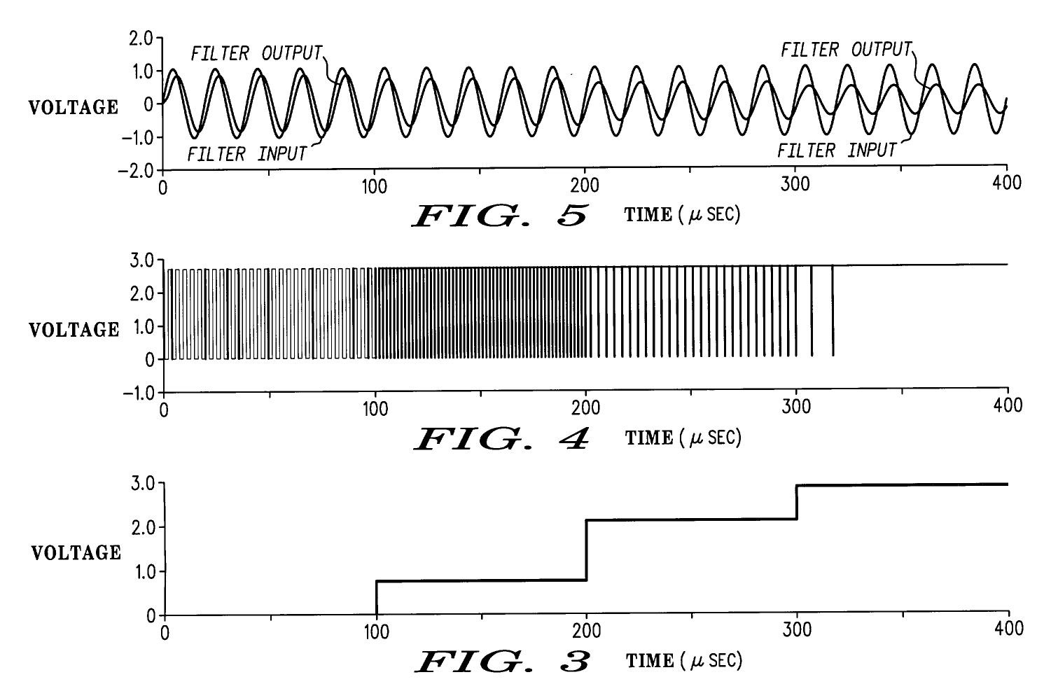

Operation of the filter device 19 will be discussed with reference to FIGS. 3-5. These figures represent surprising results arising from simulation and experimental activities that were conducted. As shown in FIG. 3, input control signals of different levels within the input values associated with the static filtering levels were applied to the modulator 14 via the input device 12 for four different time periods, each nominally 100 microseconds in length. During a first time period through the fourth time period, the input control signal was 0 V, 0.67V, 2.0 V and 2.7 V respectively. As shown in FIG. 4, during these time periods the quantized signal of the modulator 14 rapidly switched between 0 V and 2.7 V at different varying frequencies but with ever increasing proportions of time spent at the high voltage state for activating the low and high static filtering levels or frequency responses. Although the filter device 19 is switching between the high and low frequency responses, the specific pattern of this switching will result in the filter device 19 obtaining or effecting a performance level that corresponds to a new frequency response or corner frequency or filter level. FIG. 5 shows the performance of the filter device 19 during the four time periods. As shown via different amplitudes and phase shifts between the input and output signals, the four input control signals have caused the filter device 19 to obtain or generate four different corner frequencies or filtering levels, even though the device only has two static filtering levels. The filtering level obtained is proportional to the input control signal applied to the modulator 18. More specifically, during the second and third time periods, the performance of the filter device 19 demonstrates and corresponds to two new corner frequencies or frequency responses or filtering levels that are different and distinct from either of the two static filtering levels.

In the above example, the filter device 19 only has two static filtering levels. However, the present invention is not limited to circuit devices having two operating states. The present invention could be applied to circuit devices having numerous static operating states. The modulator 14 would only need to generate outputs that correspond to all of the operating states. For example, if a circuit device had four operating states, the modulator 14 would have to generate a quantized signal with four different states and would have to switch between these four quantized signals with the proportion of time spent at each state corresponding to the input control signal. In this case, where the quantizer 56 would require four possible output states rather than two, these could be represented by two signals, each with two possible states.

The present invention is not limited to filter devices 19. The present invention could be applied to other circuit devices such as amplifiers (not shown) or oscillators (not shown). In an amplifier, for example, an input control signal would be selected that corresponds to a gain level within static gain levels of the amplifier. The input control signal would be quantized for generating a quantized signal that switches between the two gain levels of the amplifier with the proportion of time spent at any one level corresponding to the control signal. The result when the quantized signal was applied to the amplifier would be a new gain level for the amplifier lying between the two static levels and corresponding to the input control signal. A similar technique can be used to provide a new effective frequency for an oscillator with two selectable frequencies.

Some of the advantages of the present invention include providing an ability to dynamically choose a new operating state of a circuit device by applying an input signal that is proportional to the new operating state. Also, the present invention eliminates a need to replace a circuit device if more operating states are needed than those provided by the circuit device, which can result in a reduced associated cost.

Therefore, the present invention provides a novel methodology and device for dynamically increasing the effective operating states of a circuit device by selecting an input control signal that is within a range corresponding to static operating states of the circuit device 18, quantizing the input control signal by, for example, a modulator 14 for generating a quantized signal that corresponds to static operating states of the circuit device, and applying the quantized signal to the circuit device 18 in a specific pattern for generating a new operating state different than the static operating states of the circuit device.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A device for increasing a number of effective operating states of a circuit device comprising:
an input terminal for receiving an input control signal within a range corresponding to static operating states of the circuit device;
a sigma delta modulator for quantizing the input control signal to provide a quantized signal; and
an output terminal for applying the quantized signal to the circuit device for selecting a new effective operating state corresponding to the input control signal.

2. The device of claim 1, wherein the sigma delta modulator is further for switching between static operating states of the circuit device to generate a time averaged response of the circuit device that is within the range corresponding to the static operating states of the circuit device and consistent with the input control signal.

3. The device of claim 2, wherein the sigma delta modulator is further for switching between static operating states in a specific pattern for generating the new effective operating state consistent with the input control signal.

4. The device of claim 1, wherein the sigma delta modulator is further for matching the input control signal to a specific pattern of the static operating states of the circuit device.

5. The device of claim 1, wherein the circuit device comprises one of an amplifier, an oscillator and a filter.

6. The device of claim 1, wherein the sigma delta modulator and circuit device are fabricated as a single integrated circuit.

7. A filtering device with dynamic operating state capability comprising:
a filter circuit for filtering an input signal, the filter circuit including a plurality of transmission gates associated with respective filter parameters for choosing one of a plurality of static filtering levels; and
a sigma delta modulator in electronic communication with the plurality of transmission gates for commanding a switching operation of the plurality of transmission gates in a specific pattern,
wherein a time average of a performance of the filter circuit is a filtering level different than the plurality of static filtering levels.

8. The filtering device of claim 7, wherein the filtering device further comprises a first high resistor and second high resistor for generating a higher frequency filtering and a first low resistor and a second low resistor for generating a lower frequency filtering.

9. A method of dynamically increasing operating states of a circuit device comprising:
selecting an input control signal that is within a range corresponding to static operating states of the circuit device;
quantizing the input control signal for generating a quantized signal; and
applying the quantized signal to the circuit device for generating a new effective operating state of the circuit device corresponding to the input control signal.

10. The method of claim 9, wherein the applying the quantized signal to the circuit device for generating the new effective operating state further comprises switching between the static operating states so that a time average of a performance of the circuit device corresponds to the new effective operating state, where the new effective operating state is different than the static operating states of the circuit device.

11. The method of claim 9, wherein the selecting an input control signal that is within a range corresponding to static operating states of the circuit device further comprises selecting an input control signal level that is proportional to the new operating state.

12. The method of claim 9, wherein the quantizing the input control signal for generating a quantized signal further comprises:
amplifying the input control signal with a buffered feedback for generating an amplified output and subsequently integrating the amplified output for generating an integrated output;
amplifying the integrated output to provide an integrated output and integrating the amplified integrated output, wherein the amplifying and integrating are sequentially performed a predetermined number of times to provide a final integrated output;
generating the quantized signal based upon a value of the final integrated output.

13. The method of claim 12, wherein the generating the quantized signal based upon a value of a final integrated output further comprises generating a quantized signal that corresponds to the input control signal relative to one of the static operating states of the circuit device.

14. The method of claim 9, wherein:
the selecting an input control signal that is within a range corresponding to static operating states of the circuit device further comprises selecting an input control signal corresponding to a frequency response within static frequency responses of a filter circuit;
the quantizing the input control signal for generating a quantized signal further comprises quantizing the input control signal for generating the quantized signal that corresponds to the frequency response within the static frequency responses of the filter circuit; and
the applying the quantized signal to the circuit device for generating a new effective operating state corresponding to the input control signal further comprises applying the quantized signal to the filter circuit for generating the frequency response different than the static frequency responses of the filter circuit.

15. The method of claim 9, wherein:
the selecting an input control signal that is within a range corresponding to static operating states of the circuit device further comprises selecting an input control signal that is within static gain levels of an amplifier;
the quantizing the input control signal for generating a quantized signal further comprises quantizing the input control signal for generating the quantized signal corresponding to a new effective gain level of the amplifier; and
the applying the quantized signal to the circuit device for generating a new effective operating state corresponding to the input control signal, further comprises applying the quantized signal to the amplifier for generating the new effective gain level of the amplifier.

16. The method of claim 9, wherein:
the selecting an input control signal that is within a range corresponding to static operating states of the circuit device further comprises selecting an input control signal that is within static frequencies of an oscillator;
the quantizing the input control signal for generating a quantized signal further comprises quantizing the input control signal for generating the quantized signal corresponding to a new effective frequency of the oscillator; and
the applying the quantized signal to the circuit device for generating a new effective operating state corresponding to the input control signal, further comprises applying the quantized signal to the oscillator for generating the new effective frequency of the oscillator.
